(19) United States
(12) Patent Application Publication
(10) Pub. No.: US 2001/0026080 A1
(43) Pub. Date: Oct. 4, 2001

(54) Compact hydraulic excavator

(75) Inventor: Yoshiaki Murakami, Hiroshima-shi (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: KOBELCO CONSTRUCTION MACHINERY CO., LTD., Hiroshima-shi (JP)

(21) Appl. No.: 09/813,987

(22) Filed: Mar. 22, 2001

(30) Foreign Application Priority Data
Mar. 31, 2000 (JP) 2000-096640

(51) Int. Cl. B60N 2/00

(52) U.S. Cl. 296/190.08; 296/63

(57) ABSTRACT

The present invention provides a compact hydraulic excavator comprising: a lower traveling body, an upper rotating body installed rotatably on the lower traveling body, an apparatus cover risen from a floor plate of the upper rotating body, an operator's seat arranged on the apparatus cover, an operator's seat fixing member for fixing the operator's seat, a cabin provided astride of the apparatus cover and the floor plate, the apparatus cover having the side and the back surface exposed to outside so that the cabin serves as a part of the side and the back surface, and a mounting plate projected substantially in a horizontal direction from the operator's seat fixing member, the side wall of the cabin being risen from the outer circumferential edge of the mounting plate. According to the present invention, it is possible to install a larger cabin than the size of an existing compact hydraulic excavator without newly re-designing an apparatus cover.

### BACKGROUND OF THE INVENTION

1. Field of the Invention

The present invention relates to a compact hydraulic excavator having a cabin installed thereon.

2. Description of the Related Art

Conventionally, the compact hydraulic excavator is not of a cabin construction, circumference of which is covered, as in a middle-sized or large-sized excavator. In the compact excavator, it is general that an operator's seat is open to outside. However, in consideration of the falling down of the excavator, it is necessary to take some measures so that an operator is not thrown out of the operator's seat.

From the viewpoint of above, there are contemplated measures for installing a cabin on the upper rotating body of the compact hydraulic excavator. However, in the compact hydraulic excavator, a space above the upper rotating body is severely restricted. Therefore, if an attempt is made to arrange the apparatus cover storing an engine unit and the like and the cabin independently, there poses a problem that the size of a cabin cannot be made larger.

There are further contemplated measures for serving the cabin as the apparatus cover in order to increase the size of a cabin. In this case, it is necessary for the cabin to provide an opening for inspecting the engine and for fueling.

It is preferred that a cabin having as large a size as possible be installed on the upper rotating body of the compact hydraulic excavator to improve the residentiality. However, there is a problem, for the reason described above, that for example, the constitution of the cabin of the middle-sized excavator can not be applied to the compact hydraulic excavator without modification. Further, there is a problem that such a constitution as described above cannot be applied to the compact hydraulic excavator unless re-designing is made including the apparatus cover. Of course, the re-designed cabin cannot be applied to the existing compact hydraulic excavator.

### SUMMARY OF THE INVENTION

It is an object of the present invention to provide a compact hydraulic excavator constituted so that a large-sized cabin may be mounted on the compact hydraulic excavator without changing the design of a layout of the existing apparatus cover.

The present invention provides a compact hydraulic excavator having the following constitutions: a lower traveling body, an upper rotating body installed rotatably on the lower traveling body, an apparatus cover risen from a floor plate of the upper rotating body, an operator's seat arranged on the apparatus cover, an operator's seat fixing member for fixing the operator's seat, a cabin provided astride of the apparatus cover and the floor plate, the apparatus cover having a side and a back surface exposed to outside so that the cabin serves as a part of the side and the back surface, and a mounting plate projected substantially in a horizontal direction from the operator's seat fixing member, the side wall of the cabin being risen from the outer circumferential edge of the mounting plate.

In this case, since the cabin is installed on the mounting plate projected from a seat support plate as the operator's seat fixing member, the large-sized cabin can be mounted without being restricted by the arrangement of the apparatus cover. Further, where the present invention is applied to the existing hydraulic excavator, the seat support plate with a mounting plate according to the present invention is mounted in place of the existing seat support plate, whereby the effect of the present invention can be achieved. That is, it is possible to install a larger cabin than the size for the compact hydraulic excavator. Further, since the cabin is installed in the state that the side and the back surface of the apparatus cover are exposed to serve as a part of the side and the back surface of the cabin, it is not necessary to re-design the apparatus cover.

The apparatus cover stores therein an engine unit, a hydraulic apparatus, a fuel tank and so on.

Further, preferably, the back surface of the apparatus cover is constituted to be capable of being opened in a spring-up type, and the rear part of the cabin opposite to the back surface of the apparatus cover is formed to have an inclined surface so as to provide a large spring-up angle.

In this case, the back surface of the apparatus cover to be opened never interfere with the cabin. Since the spring-up angle can be made large, an open area for maintenance can be widened.

Furthermore, preferably, the outer wall of the cabin is connected substantially facing to the outer wall of the rotating frame of the upper rotating body.

In this case, the larger cabin than the size for a compact hydraulic excavator can be installed on the compact hydraulic excavator for which space is restricted.

### BRIEF DESCRIPTION OF THE DRAWINGS

FIG. 1A and FIG. 1B are respectively external views of a hydraulic excavator to which is applied a cabin for a compact hydraulic excavator according to the present invention, particularly, FIG. 1A being a front view, and FIG. 1B being a right side view;

FIG. 2 is a front view showing the fixing construction of a bracket for supporting the cabin;

FIG. 3 is a left side view likewise showing the fixing construction;

FIG. 4 is a right side view likewise showing the fixing construction; and

FIG. 5 is a perspective view showing the constitution of a bracket.

### DESCRIPTION O THE PREFERRED EMBODIMENTS

The present invention will be described in detail hereinafter on the basis of one embodiment of the invention shown in the drawings.

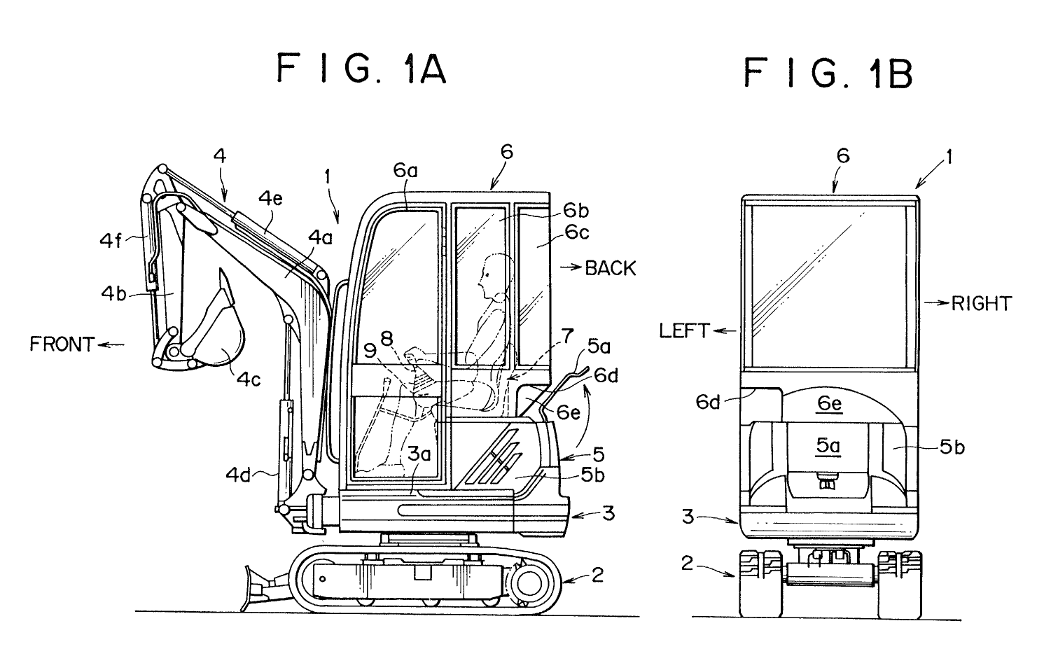

FIGS. 1A and 1B show the constitution of a compact hydraulic excavator to which is applied a cabin for a compact hydraulic excavator according to the present invention. FIG. 1A is a front view, and FIG. 1B is a right side view of the excavator as viewed from the back.

In both the figures, in a compact hydraulic excavator 1, an upper rotating body 3 is installed rotatably on a lower traveling body 2 of a crawler type. A front attachment 4 is provided on the front side of the upper rotating body 3. The front attachment 4 mainly comprises a boom 4a, an arm 4b, a bucket 4c, and a boom cylinder 4d, an arm cylinder 4e and a bucket cylinder 4f for driving the first mentioned respective elements.

On the back side of the upper rotating body 3 is provided an apparatus cover 5 for storing therein an engine unit, a fuel tank, a working oil tank, a battery and so on (not shown). A cabin 6 is provided astride of the apparatus cover 5 and a floor plate 3a positioned at operator's feet in the upper rotating body 3.

It is constituted so that an outer wall of the cabin 6 is connected substantially facing to an outer wall of a rotating frame of the upper rotating body 3. Thereby, even the compact hydraulic excavator 1 can secure the greatest residential space. The cabin 6 is interiorly provided with an operator's seat 7. At both lateral sides of the operator's seat 7 is arranged each control box 9 provided with an operating lever 8.

On a side of the cabin 6 is provided a door 6a which is opened and closed when an operator gets on and off. Windows 6b and 6c of the inlaid type are provided at the rear of the door 6a. An inclined surface 6e is formed at the lower part behind the cabin 6 so as to form a wedge-like clearance relative to the upper surface of the apparatus cover 5. By the provision of the inclined surface 6e, a large spring-up angle can be provided when a rear cover (a rear surface of the apparatus cover) 5a of the apparatus cover 5 is opened.

In the figure, 6d is formed at the end widthwise of the inclined surface 6e. This 6d serves as a cut part provided in order to secure a working space during maintenance.

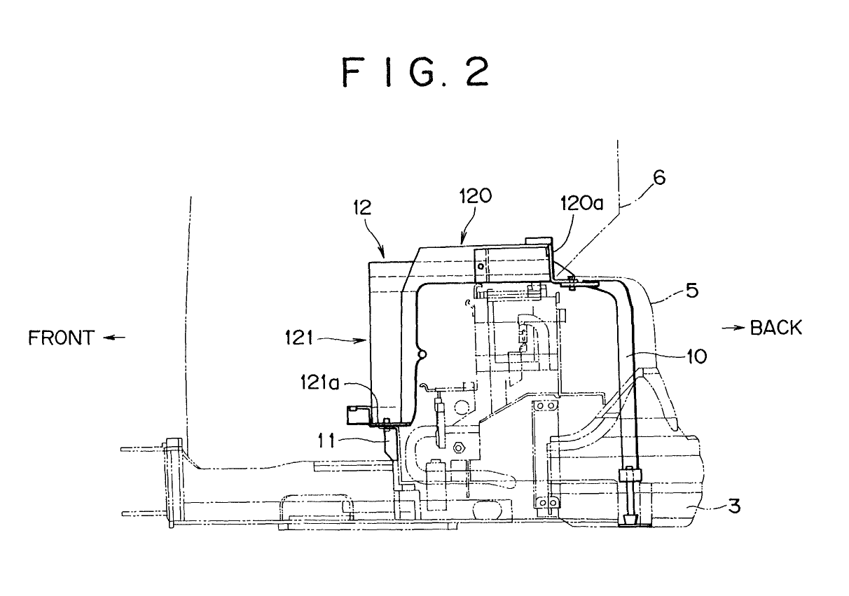

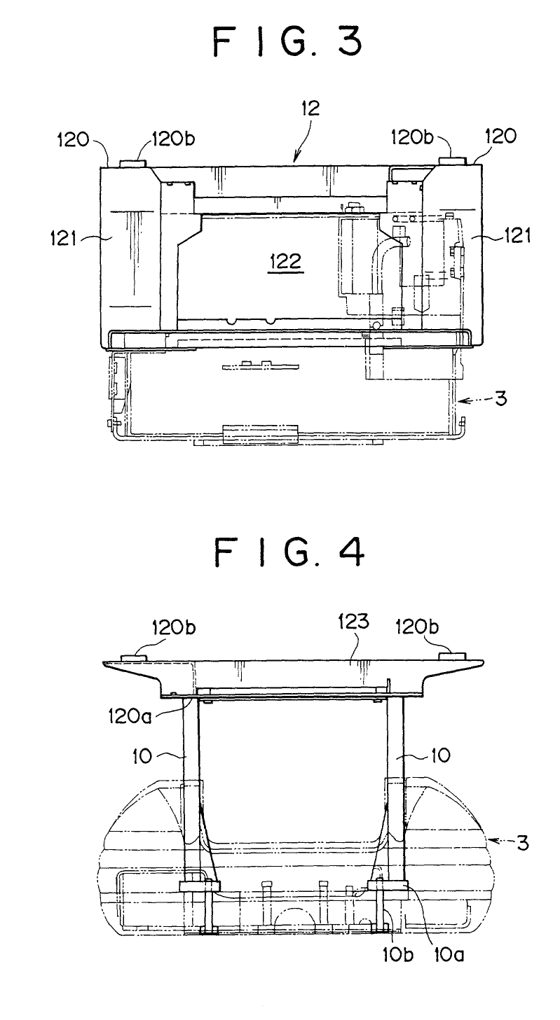

FIGS. 2 to 4 show the mounting construction for the cabin 6. FIG. 2 is a front view; FIG. 3 is a left side view of the excavator as viewed from front; and FIG. 4 is a right side view thereof as viewed from back.

In FIG. 2, a pair of supports 10, 10 (only one on this side is shown) are stood upright at the rear of the upper rotating body 3. A pair of metal fittings 11, 11 (only one on this side is shown) are projected in the central part of the upper rotating body 3. A bracket 12 for supporting the cabin 6 is secured to those supports 10, 10 and those metal fittings 11, 11.

The bracket 12 is formed into an L-shaped steel so as to avoid the apparatus cover 5. An operator's seat 7, control boxes 9 and so on are disposed on the bracket 12.

Connecting metal fittings 120a formed from an L-shaped steel to be connected to the supports 10, 10 is provided at the rear end of an upper plate 120 of the bracket 12. On the other hand, connecting metal fittings 121a, 121a to be connected to the metal fittings 11, 11 are provided on the lower ends of front plates 121, 121 (only one on this side is shown) of the bracket 12.

The pair of front plates 121 are arranged apart widthwise of the excavator, as shown in FIG. 3. An opening 122 therebetween is shielded by a front panel formed with a blow-off hole of a heater not shown.

Each rear end of the upper plate 120 is connected widthwise of the excavator by a web-like connecting plate 123. The connecting metal fittings 120a is secured to the connecting plate 123.

A plate-like connecting leg 10a is provided at the lower end of each of the supports 10, 10. The connecting leg 10a is secured to the rotating frame through a bolt 10b. It is noted that a fixed seat 120b for locating and fixing the frame of the cabin 6 is mounted at the rear end of and outwardly of each of the upper plate 120.

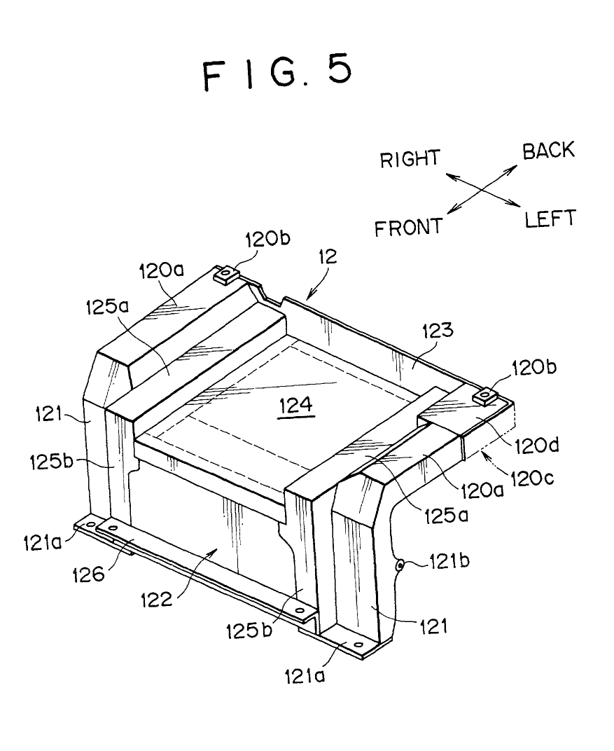

FIG. 5 shows the bracket 12 in an enlarged scale.

In the figure, the bracket 12 has an operator's seat fixing plate (a seat support) 124 on which the operator's seat 7 is mounted. Each control box fixing part 125a formed from a tube for mounting a control box is connected to both sides (widthwise of the excavator) of the operator's seat fixing plate 124. An upper plate 120a is connected externally of the control box fixing part 125a. The upper plate 120a extends outward along the upper surface of the apparatus cover 5. The upper plate 120a functions as a mounting plate for mounting the cabin 6.

A second front plate 125b is suspended from the front end of the control box fixing part 125a. The second front plate 125b is connected to the front plate 121. A connecting plate 126 formed of L-shaped steel is mounted at the lower end of the second front plate 125b. The rear edge of the floor plate 3a is connected to the connecting plate 126.

Mounting seats 121a, 121a are provided at the lower ends of the respective front plates 121. The mounting seats 121a, 121a are secured to the floor plate 3a through bolts not shown. A connecting piece 121b with a hole to be connected to a frame of a side cover 5b (see FIGS. 1A and 1B) is provided on the side of the front plate 121.

A bag part 120d in the shape, in which a corner (indicated by dash-dotted contour lines) 120c is cut, is provided at the rear end of the upper plate 120a on the left side. This bag part 120d is provided to open the side cover 5b so that the working space is secured when maintenance takes place.

In this manner, the bracket 12 is constituted separately from the apparatus cover 5 so as to cover the upper surface and the front surface of the apparatus cover 5. Moreover, the upper plate 120a is over-hung widthwise of the excavator for expansion. Because of this, the size of the cabin 6 installed on the bracket 12 can be enlarged.

Also, the outer edge of the upper plate 120a is extended so as to substantially meet the contours of the rotating frame of the upper rotating body 3. Because of this, the cabin 6 of which bottom is substantially equal to a floor area of the rotating frame can be realized. That is, it is possible to form a cabin equal to the middle-sized machine with respect to the compact hydraulic excavator 1.

I claim:

1. A compact hydraulic excavator, comprising:
a lower traveling body;
an upper rotating body installed rotatably on said lower traveling body;
an apparatus cover risen from a floor plate of said upper rotating body;
an operator's seat arranged on said apparatus cover;
an operator's seat fixing member for fixing said operator's seat;
a cabin provided astride of said apparatus cover and said floor plate, said apparatus cover having a side and a back surface exposed to outside so that the side and the back surface serve as a part of a side and a back surface of the cabin; and
a mounting plate projected substantially in a horizontal direction from said operator's seat fixing member, a side wall of said cabin being risen from an outer circumferential edge of the mounting plate.

2. The compact hydraulic excavator according to claim 1 wherein apparatuses including an engine unit, a hydraulic apparatus, and a fuel tank are stored in said apparatus cover.

3. The compact hydraulic excavator according to claim 1 which is constituted so that a rear surface of said apparatus cover can be opened in a spring-up system.

4. The compact hydraulic excavator according to claim 3 wherein a rear part of said cabin opposite to the rear surface of said apparatus cover is formed to be an inclined surface so as to provide a large spring-up angle of said rear surface.

5. The compact hydraulic excavator according to claim 1 wherein an outer wall of said cabin is connected substantially facing to an outer wall of said frame of said upper rotating body.

6. The compact hydraulic excavator according to claim 1 wherein said operator's seat fixing member comprises a seat support plate.

7. The compact hydraulic excavator according to claim 6 wherein said seat support plate and said mounting plate are integrally formed into a box-like frame detachably with respect to the rotating frame of said upper rotating body.

8. The compact hydraulic excavator according to claim 4 wherein said cable has a cut at a rear lower part of said cabin and at an end widthwise of said cabin.
